(19) United States
(12) Patent Application Publication
(10) Pub. No.: US 2009/0208219 A1
(43) Pub. Date: Aug. 20, 2009

(54) Multimode Communications System

(76) Inventors: Mark Rhodes, West Lothian (GB); Brandan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/372,513

(22) Filed: Feb. 17, 2009

Related U.S. Application Data
(60) Provisional application No. 61/028,926, filed on Feb. 15, 2008.

(30) Foreign Application Priority Data
Feb. 15, 2009 (GB) 0802807.8

(51) Int. Cl. H04B 10/00; H04B 13/02

(52) U.S. Cl. 398/104; 398/115; 455/40; 367/131

(57) ABSTRACT

A multimode wireless communications system that uses the three mechanisms of light, radio and acoustic carriers either in combination or through selection of the most appropriate carrier.

### CROSS-REFERENCE TO RELATED APPLICATIONS

This application claims the benefit of U.S. Ser. No. 61/028,926 filed Feb. 15, 2008 and GB 0802807.8 filed Feb. 15, 2008.

### INTRODUCTION

The present invention relates to a wireless underwater communications system that uses optical, acoustic and radio frequency electromagnetic carrier signals.

### BACKGROUND

The underwater domain has long been recognised as a challenging environment for establishing wireless communications. While radio systems dominate atmospheric wireless communications applications, radio waves are attenuated severely in water so acoustic carriers have commonly been adopted for long range underwater wireless communications. It has long been recognised that optical carriers also offer some capability for underwater wireless communications and the very high frequency of optical carriers offers the possibility of achieving very high data rates.

Each of these three carrier mechanisms exhibit unique strengths and weaknesses.

Acoustic systems typically offer up to 10 kbps data rate and can achieve a range of many kilometres. Their horizontal range is more limited due to refraction effects caused by the vertical pressure gradient within a body of water. Acoustic links are also problematic in shallow water or restricted volumes of water due to multi-path reflections, air bubbles and acoustic noise.

Water and particularly sea water are partially conductive and in this medium, radio attenuation increases rapidly with frequency. This has driven sub-sea radio communications systems toward operation at very low frequencies to maximize operational range. The nature and advantages of electromagnetic and/or magneto-inductive signals and of magnetic antennas for communication through water are discussed in our co-pending patent application, “Underwater Communication System” PCT/GB2006/002123, the details of which are hereby incorporated by reference. Sub-sea radio communications systems typically operate below 10 kHz and offer communications up to 100 bps at 10's of metres range. Radio propagation is not degraded in any of the operating conditions which present difficulties for acoustic systems.

Optical systems offer the highest potential bandwidth for short range through water wireless communications. Their terahertz carrier frequency can practically support data rates of 100's of Mega bits per second. Common experience of water turbidity indicates that, while this method potentially has the highest data rate capabilities, it is also the least robust in practical operating scenarios. Optical systems function well in clear open water but disturbance of sediment, marine fouling and periodic variations in turbidity can all be problematic.

Optical and radio based systems offer communications capabilities through air as well as underwater while acoustic communications have limited performance in air.

### SUMMARY OF INVENTION

According to one aspect of the present invention there is provided a multimode wireless communications system that uses light, radio and acoustic carriers either in combination or through selection of a single carrier.

According to another aspect of the present invention there is provided a multimode wireless communications system wherein at least two of light, radio and acoustic carriers are used in combination.

According to another aspect of the present invention there is provided a multimode wireless communications system wherein at least two of light, radio and acoustic carriers are used in combination to achieve a greater data rate than each system can support individually.

According to yet another aspect of the present invention there is provided a multimode wireless communications system provided with light, radio and acoustic carriers wherein a single carrier is selected to establish a communications link based on the bit error ratio achievable through each mechanism.

According to yet another aspect of the present invention there is provided a multimode wireless communications system provided with light, radio and acoustic carriers wherein data is received through one carrier mechanism, buffered or stored and re-transmitted using a mechanism selected independently from the receive mechanism.

According to still another aspect of the invention there is provided a multimode wireless communications system comprising a light transmitter and/or receiver, and a radio transmitter and/or receiver for sending and/or receiving light and radio signals respectively.

The system may be adapted to communicate using light and/or radio signals in combination or individually.

The system may be adapted to determine which of the light and radio signals is appropriate for prevailing operating conditions.

The system may be operable to receive data using one of light and radio signals and re-transmit using the other one.

The system may be adapted to transmit the same data over multiple carrier mechanisms.

The system may be configured to select a received data stream from multiple carrier mechanisms based on received bit error rate.

The radio signal may have a frequency between 100 Hz and 10 MHz.

The optical signal may have a frequency between 300 THz and 3,000 THz.

According to yet another aspect of the invention, there is provided a multimode wireless communications system comprising a light transmitter and/or receiver and an acoustic transmitter and/or receiver for sending and/or receiving light and acoustic signals respectively.

The system may be adapted to communicate using light and/or acoustic signals in combination or individually.

The system may be adapted to determine which of the light and acoustic signals is appropriate for prevailing operating conditions.

The system may be operable to receive data using one of light and acoustic signals and re-transmit using the other one.

The system may be adapted to transmit the same data over multiple carrier mechanisms.

The system may be configured to select a received data stream from multiple carrier mechanisms based on received bit error rate.

The optical signal may have a frequency between 300 THz and 3,000 THz.

The acoustic signals may have a frequency between 1 kHz and 100 kHz.

### BRIEF DESCRIPTION OF DRAWINGS

Various aspects of the invention will now be described by way of example only and with reference to the accompanying drawings, of which:

FIG. 1 shows electromagnetic absorption through water from X-ray wavelengths to VHF radio;

FIG. 2 shows a more detailed plot of the optical spectrum absorption characteristics;

FIG. 3 shows variation of attenuation with frequency through water in the radio spectrum;

FIG. 4 shows a block diagram of the combined wireless communication system;

FIG. 5 shows a flow diagram representing single mode system operation;

FIG. 6 shows a block diagram of an optical, radio or acoustic transmitter;

FIG. 7 shows a block diagram of an optical, radio or acoustic receiver;

FIG. 8 shows a block diagram of a framing and routing system for controlling transmission over a three mode system;

FIG. 9 shows a block diagram of a de-framing and routing system for controlling reception over a three mode system;

### DETAILED DESCRIPTION OF THE DRAWINGS

The preceding text outlines some of the strengths and weaknesses of radio, optical and acoustic based underwater wireless communications systems. These three carriers are transmitted through very different physical propagation mechanisms and so there is very little overlap between difficult operating conditions for the three modes.

A system which combines these three mechanisms can offer very robust quality of service over a variety of operating conditions. The combined “multimode wireless modem” system will deliver the highest possible data rate transfer for the prevailing operating conditions and range.

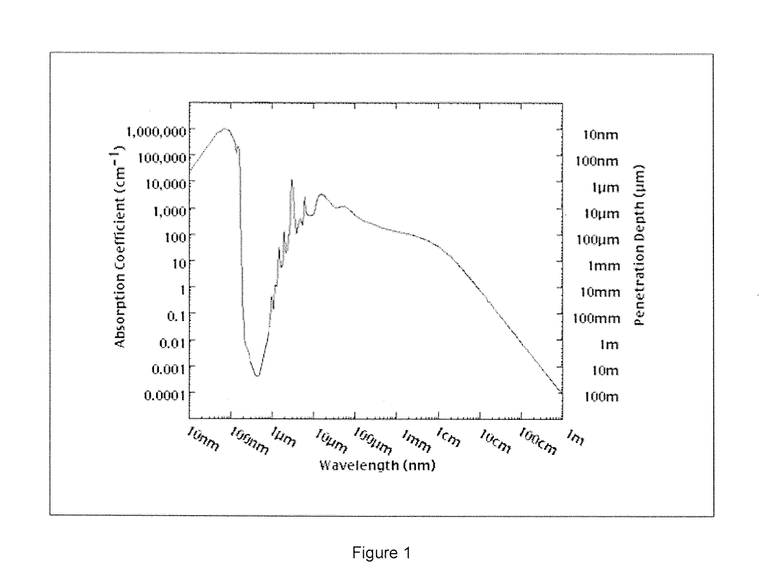

FIG. 1 shows electromagnetic absorption through water from X-ray wavelengths to VHF radio. The plot shows opportunities for communication exist in the optical spectrum around 500 nm and in the radio spectrum above 100 cm wavelength where attenuation allows communication at useful range. Wavelength is modified by the conductive nature of seawater so the wavelengths shown here should not be converted to frequencies using the standard through air formulae.

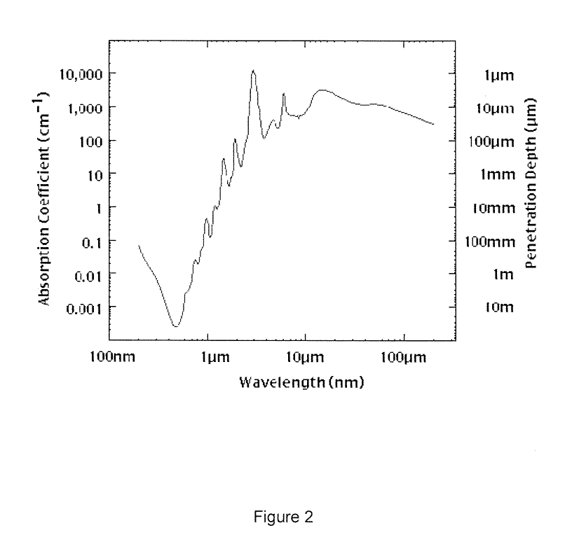

FIG. 2 shows a more detailed plot of the optical spectrum absorption characteristics. The plot clearly shows a minimum occurs in the absorption spectrum at around 500 nm wavelength which corresponds to the transition from blue to green light in the visible spectrum.

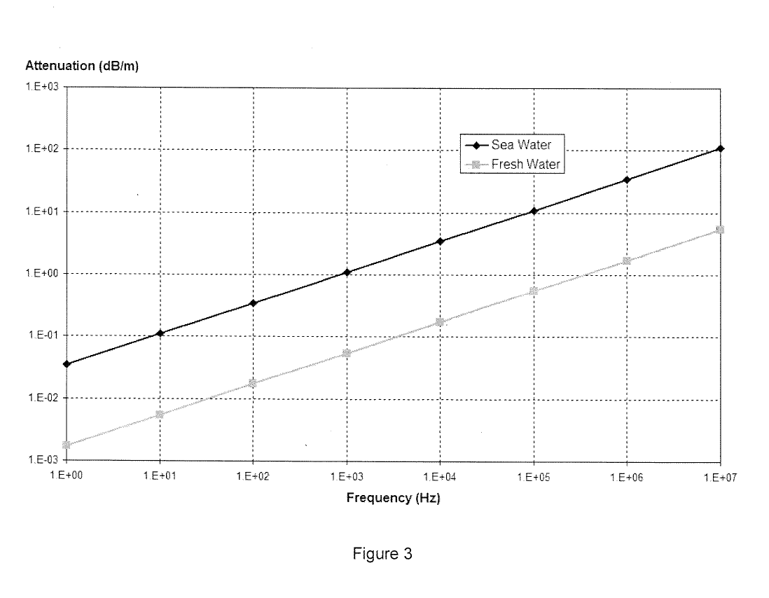

FIG. 3 shows variation of attenuation with frequency through water in the radio spectrum. Attenuation is much higher in the partially conductive medium of sea water. Attenuation increases rapidly with increasing frequency. This plot illustrates the range advantage that can be gained by operating at low frequencies.

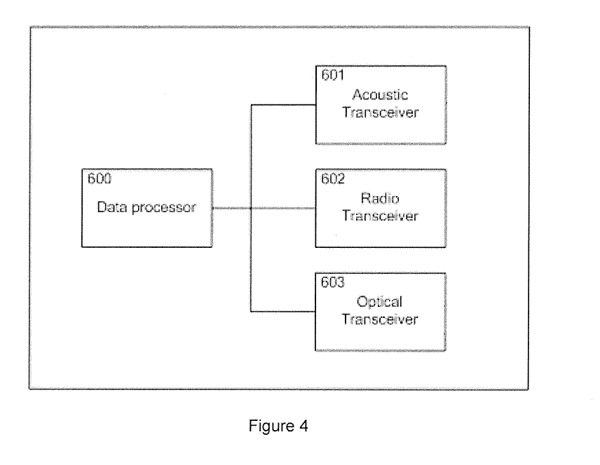

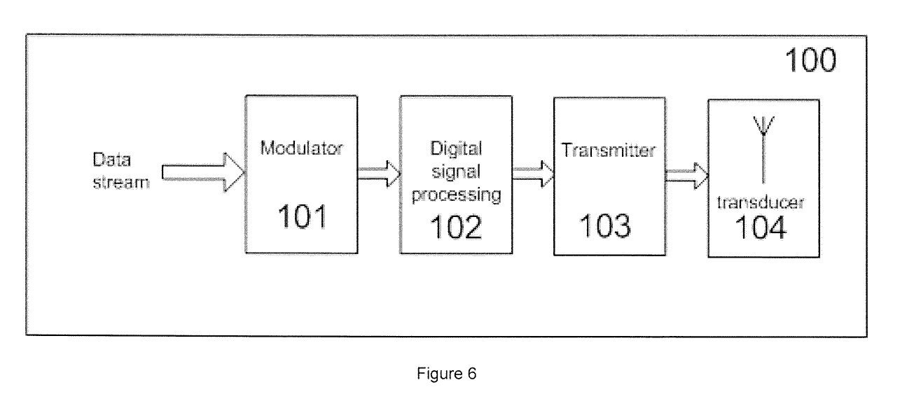

FIG. 4 shows a block diagram of the combined wireless communication system. Data processor 600 coordinates operation of the system. Data processor 600 acts as the interface to the client data generating or recipient system. Data processor 600 selects which of acoustic transceiver 601, radio transceiver 602, or optical transceiver 603 are appropriate for the prevailing operational conditions. Each transceiver system consists of a combination of the transmit and receive functions described over FIGS. 6 to 8. Time domain, frequency domain and other multiplexing methods are well know to those skilled in the art of digital communications systems and will not be repeated here.

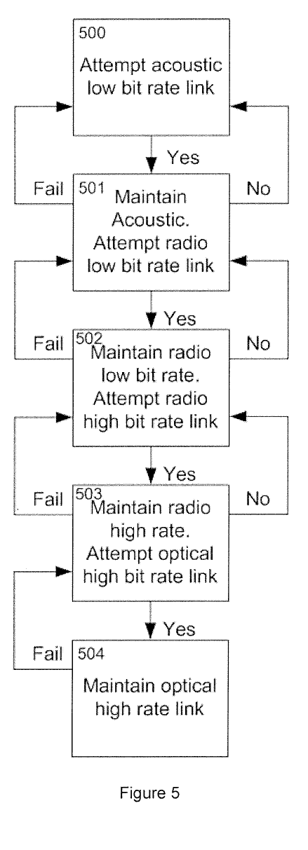

FIG. 5 shows a flow diagram of single mode system control decision flow. The system will initially attempt to communicate using a low bit rate acoustic link 500. If this link is successfully established the acoustic link can be used to coordinate both ends of the link to attempt radio communications 501. If the radio link is successfully established it can be used to coordinate both ends of the link to attempt high bit rate radio communications 502. If the high bit rate radio link is successfully established it can be used to coordinate both ends of the link to attempt optical communications 503. The communications link will continue on the high capacity optical link 504 unless this link is interrupted at which point the system will revert to lower bit rate links as shown by FIG. 5. The system can use the described operational flow either to select the most appropriate single carrier mechanism or to simultaneously communicate over multiple carriers by retaining operation over each lower capacity link as the next link is enabled.

FIG. 6 shows a block diagram of an optical, radio or acoustic transmitter. A data stream is passed to modulator 101 which encodes a carrier signal with a digital or analogue representation of the data and passes the signal to digital signal processing module 102. Transmitter 103 generates the drive signal appropriate for the selected transducer 104. In a radio transmitter subsystem transducer 104 may be a loop antenna; solenoid; solenoid formed around a high relative permeability material or two contacts in direct conductive contact with the water. In an optical system transducer 104 may be a laser diode. In an acoustic system transducer 104 may be a piezoelectric transducer.

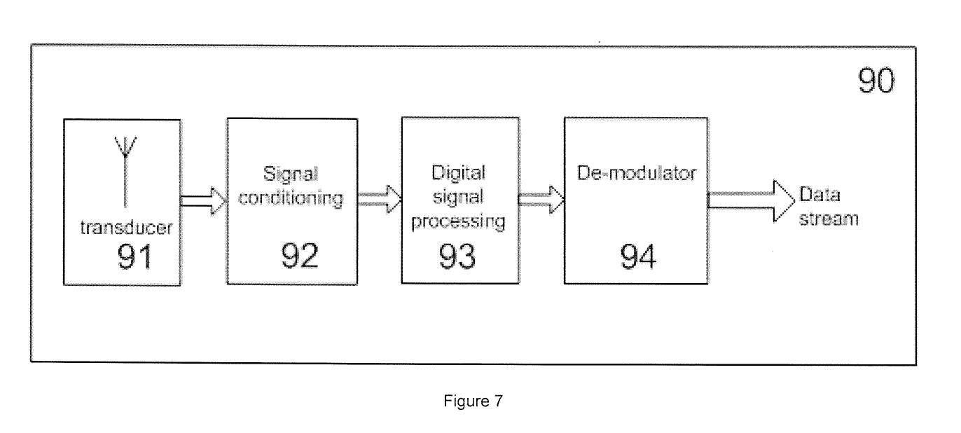

FIG. 7 shows a block diagram of an optical, radio or acoustic receiver. Transducer 91 converts a signal in the transmission medium to an electrical signal at the input to receive amplifier 92. In a radio system transducer 91 may be a loop antenna; solenoid; solenoid formed around a high relative permeability material or two contacts in direct conductive contact with the water. In an acoustic system transducer 91 may be a piezoelectric transducer. In an optical system transducer 91 may be a photodiode. Signal conditioning subsystem 92 may include a receive amplifier designed to increase the received signal amplitude while minimising added electrical noise and may also perform a frequency band limiting function. Digital signal processor 93 further conditions the received signal and may include frequency and phase compensation for distortion introduced by transmission through water. De-modulator 94 recovers data from the modulated received carrier signal.

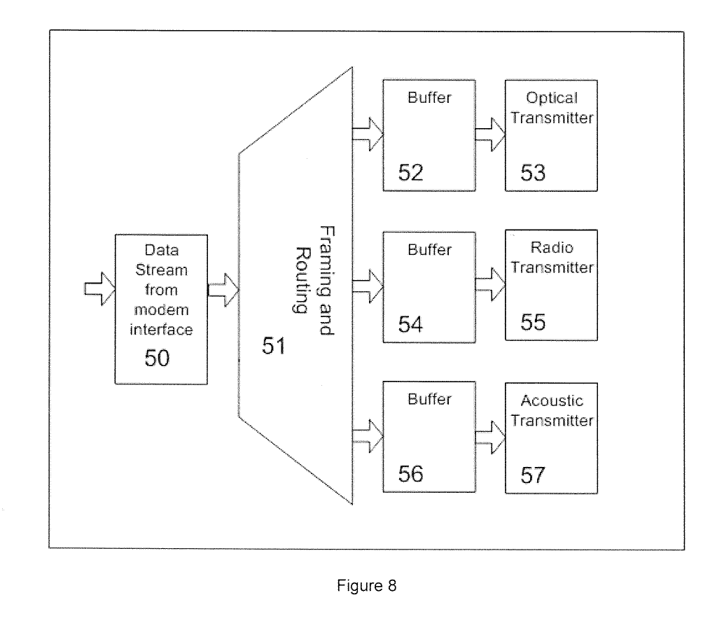

FIG. 8 shows a block diagram of a framing and routing system for controlling transmission over a three mode system. Data is provided by a client system at the modem external data interface 50. Data may be passed over any of the three transmission channels and can be transmitted in parallel over more than one channel at different bit rates. This presents a control problem that must be overcome by the system. The incoming data must be split into packets that can be routed over any of the available channels. The packets will be transmitted at different rates over each of the different carrier channels. This will result in different communication delays for different routings. The phenomenon of packets from a common data stream arriving at a receiver with variable delay is described as introducing differential delay between data packets. Data packets may arrive at the receiver out of sequence and must be re-assembled to re-create the original data stream. Framing and routing subsystem 51 splits the data stream into packets that are appropriately sized for the lowest data rate channel currently in use. Each packet has a header that records its order in the original bit stream. Buffers 52, 54 and 56 demand data packets when they are ready to send. As sequenced packets are created they are allocated to the buffers in the order they declared themselves ready so matching each channel's throughput capacity. Subsystems 53, 55 and 57 represent optical, radio and acoustic implementations of transmitter subsystem 100 respectively. Buffers 52, 54 and 56 may be enabled or disabled to manually select a preferred transmission method or selected under automated control. Selection of transmission medium may be automated following the scheme outlined in FIG. 5 or by monitoring the bit error ratio of each transmission mechanism. Framing and routing subsystem 51 may be used to route data by the lowest bit error ratio channel available. Means for implementing an effective measure of bit error ratio by embedding control data in the transmitted packets for analysis at the receiver are well known in the communications industry and will not be repeated here.

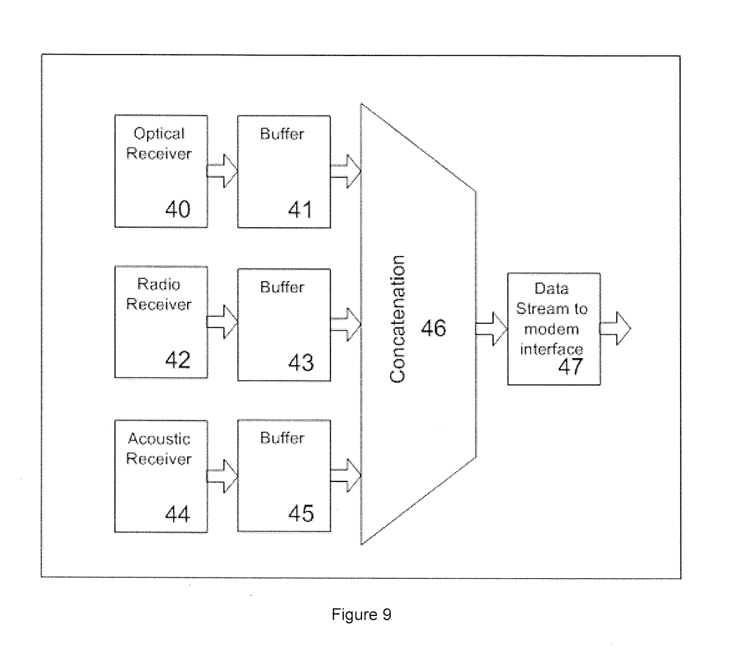

FIG. 9 shows a block diagram of a de-framing and routing system for controlling reception over a three mode system. Receivers 40, 42 and 44 represent optical, radio and acoustic receiver subsystems respectively as described by receiver 90 in FIG. 7. These receiver subsystems pass data onto buffers 41, 43 and 45 respectively. Concatenation subsystem 46 reproduces the original data stream by re-assembling the data packets according to their sequence header. Buffer capacity must be sufficient to allow storage of data from the highest bit rate channel until the associated packets arrive over the lowest bit rate channel. The re-assembled data stream is passed to the external modem data interface 47.

An underwater acoustic channel will typically support up to 10 kbps. A subsea radio link capacity will typically vary from 10 Mbps over sub-metre range to 10 bps over tens of metres and an optical link will typically support up to 100 Mbps over several metres.

The present multimode wireless communications modem which has acoustic, radio and optical integrated capabilities can function in several configurations.

In conversion mode the modem will be capable of receiving a signal over any of the three physical channels while re-transmitting using an independent choice of one of three carriers. For example, radio and optical links offer some ability to communicate through the water to air boundary while acoustic links can offer greatest range in some conditions. An acoustic channel could be used to transmit data from the bottom of the deep ocean for reception by a submerged multimode modem close to the surface. This submerged modem could re-transmit using an optical or radio channel for reception by a third modem above the water surface. This scenario also illustrates an application where one end of a multimode communications link may be above the surface of the water. Although optimised for underwater operation, in some instances the multi-mode modem could be used to establish a communications link entirely in air using radio or optical modes. The low frequency radio link is also applicable for communications through the earth in underground deployments. This capability offers flexibility of deployment in air, sea, on land or underground and this ubiquitous coverage is another operational advantage of the multimode system.

Subsea operation represents the most challenging communication environment for this multi-environment system. The multi-mode system described here will be designed to address the pressure and communication channel characteristics found in sea water. The system will be housed in a pressure container to provide protection against ingress of conductive seawater which would prevent operation of electrical equipment. Communication performance through air and underground will be somewhat reduced due to system optimisation for the seawater environment but will provide the useful capability of deployment flexibility. For example radio equipment is designed very differently for sea water operation compared to through air. Loop antennas are typically used for operation at the low radio frequencies that are required to provide useful communications range in sea water. While frequencies below 10 MHz will be used for subsea radio communications efficient portable radios designed for atmospheric communications typically operate at higher frequencies largely due to the improved efficiency of compact antennas at these frequencies. The optical, radio and acoustic transducers will all be designed for transmission and reception in seawater. Optical lenses in contact with sea water must be designed specifically for this purpose as relative refractive index of seawater is 80 compared to 1 for air. Acoustic transducers are typically designed for optimum mechanical efficiency at the intended operating frequency and these characteristics will shift very significantly when driving a water load compared to the much lighter load experienced in air.

In other operational modes the multimode wireless modem may receive data at a high bit rate, then store or buffer the data for re-transmission at a different bit rate or at a later time period. For example, rapid transfer of data using an optical link over short range from a mobile vehicle to a modem station followed by slower data rate transfer of data over longer range by radio or acoustic carriers.

In another mode the multimode wireless modem may act to select the best single signal carrier for a given operational scenario. The multimode modem will select the best carrier medium through monitoring bit error rate of each channel. In an example implementation this could be achieved by following the decision flow of FIG. 6.

In another operational mode a multimode wireless modem pair may communicate using a combination of all three carriers. Another consequence of the three very different carrier mechanisms is the negligible interference between carriers. Where conditions allow, all three data carrier mechanisms can operate simultaneously, or a combination of any two, to give a higher total data transfer rate.

In yet another mode of operation the multimode wireless communications system may transmit the same data stream over two or three carrier mechanisms for added security of data delivery. The physical carrier mechanisms are largely unrelated and events which cause interference and interruption of communication over one carrier are unlikely to interrupt the others. The received data stream may be derived from the single carrier that reports the lowest bit error ratio through data monitoring techniques. Alternatively the use of three carriers opens the possibility of majority voting on the state of each data bit for reduction in bit errors. The physical carrier mechanisms of the three modes are quite different and interference events are unlikely to create errors in more than one carrier mechanism. In a two mode system we can continually compare bits received via the two channels and we can identify differences that must have been generated by transmission errors but we must still devise a method for identifying which of the two presented states is correct. This must be achieved through one of the standard error correction techniques but with the penalty of reducing the data payload as error correction overhead is added. In a three carrier mechanism system we have the possibility of comparing three data streams. In cases where only one of the three streams disagrees with the other two we have the possibility of “majority voting” by discarding the data from the unique data stream and selecting from one of the packets that are precisely duplicated by the other two mechanisms. These parallel modes will be particularly relevant to delivery of real time data in applications such as video transmission where continuity of data delivery is highly desirable.

While the above examples have been described using a pair of communicating modems a number of multimode modems may alternatively operate to form a communicating network.

While the preceding text has described a three mode system that can communicate using light, radio or acoustic carriers some of the advantages of this system can be realised by a dual mode system that incorporates any two of the described carriers. For example a radio-acoustic system, radio-optical system or acoustic-optical system. The descriptions of these systems will be a subset of the three mode system described in detail here.

Those familiar with communications and sensing techniques will understand that the foregoing is but one possible example of the principle according to this invention. In particular, to achieve some or most of the advantages of this invention, practical implementations may not necessarily be exactly as exemplified and can include variations within the scope of the invention.

Also, whilst the systems and methods described are generally applicable to seawater, fresh water and any brackish composition in between, because relatively pure fresh water environments exhibit different electromagnetic propagation properties from saline, seawater, different operating conditions may be needed in different environments. Any optimisation required for specific saline constitutions will be obvious to any practitioner skilled in this area. Accordingly the above description of the specific embodiment is made by way of example only and not for the purposes of limitation. It will be clear to the skilled person that minor modifications may be made without significant changes to the operation described.

1. A multimode wireless communications system comprising a light transmitter and/or receiver, a radio transmitter and/or receiver and an acoustic transmitter and/or receiver for sending and/or receiving light, radio and acoustic signals respectively.

2. A system as claimed in claim 1 adapted to communicate using two or more of light, radio and acoustic signals in combination or light, radio and acoustic signals individually.

3. A system as claimed in claim 1 adapted to determine which of the light, radio and acoustic signals is appropriate for prevailing operating conditions.

4. A system as claimed in claim 1 operable in air, under water or under ground.

5. A system as claimed in claim 1 operable to receive data using one of light, radio and acoustic signals and re-transmit using a different one of light, radio and acoustic signals.

6. A system as claimed in claim 1 operable to transmit the same data over multiple carrier mechanisms.

7. A system as claimed in claim 6 operable to select a received data stream from multiple carrier mechanisms based on received bit error rate.

8. A system as claimed in claim 1 wherein the acoustic signals have a frequency between 1 kHz and 100 kHz.

9. A system as claimed in claim 1 wherein the radio signal has a frequency between 100 Hz and 10 MHz.

10. A system as claimed in claim 1 wherein the optical signal has a frequency between 300 THz and 3,000 THz.

11. A multimode wireless communications system comprising a light transmitter and/or receiver, and a radio transmitter and/or receiver for sending and/or receiving light and radio signals respectively.

12. A multimode wireless communications system comprising a light transmitter and/or receiver and an acoustic transmitter and/or receiver for sending and/or receiving light and acoustic signals respectively.

13. A communication method that uses a light transmitter and/or receiver, a radio transmitter and/or receiver and an acoustic transmitter and/or receiver for sending and/or receiving light, radio and acoustic signals respectively, the method involving selectively using one or more of the light, radio and acoustic transmitters and/or receivers for transmitting and/or receiving signals.

14. A method as claimed in claim 13 comprising selecting the one or more of the light, radio and acoustic transmitters and/or receivers depending on at least one operating condition.

15. A method as claimed in claim 13 wherein the operating condition is based on a measurement of bit error, for example a bit error ratio.

16. A method as claimed in any of claims 13 comprising simultaneously communicating using two or more of light, radio and acoustic signals at different bit rates.

17. A method as claimed in any of claims 13 comprising simultaneously transmitting a common bit stream over all three carrier mechanisms wherein the bit state is determined by comparing the received signals and selecting signals that are identical between two or more carrier mechanisms as error free data.

18. A method as claimed in any of claims 13 comprising simultaneously transmitting a common bit stream over all three carrier mechanisms and selecting at a receiver data packet(s) based on comparison of the bit errors reported by each mechanism receiver.
